(19) United States
(12) Patent Application Publication
(10) Pub. No.: US 2013/0073760 A1
(43) Pub. Date: Mar. 21, 2013

(54) AS-I COMMUNICATION COMPONENT

(71) Applicant: Bernhard Wiesgickl, Vilseck (DE)

(72) Inventor: Bernhard Wiesgickl, Vilseck (DE)

(73) Assignee: SIEMENS AKTIENGESELLSCHAFT, Munich (DE)

(21) Appl. No.: 13/701,040

(22) PCT Filed: May 17, 2011
(86) PCT No.: PCT/EP11/57914

§ 371 Date: Nov. 30, 2012

(30) Foreign Application Priority Data
Aug. 19, 2010 (EP) 10173425.9

(51) Int. Cl. G06F 13/42

(52) U.S. Cl. CPC G06F 13/4282
USPC 710/106

(57) ABSTRACT

A communication component is disclosed for communication via an AS-i line. In order to provide an improved AS-i communication component for communication via an AS-i line, it is proposed in at least one embodiment that a standard AS-i signal and an extended AS-i communication signal are sent and/or received via an AS-i line using a shared communication component.

### PRIORITY STATEMENT

This application is the national phase under 35 U.S.C. §371 of PCT International Application No. PCT/EP2011/057914 which has an International filing date of May 17, 2011, which designated the United States of America, and which claims priority to European patent application number EP 10173425 filed Aug. 19, 2010, the entire contents of each of which are hereby incorporated herein by reference.

### FIELD

At least one embodiment of the invention generally relates to an AS-i communication component for communication on a field bus system implemented in accordance with an AS-interface standard, and also an AS-i module.

### BACKGROUND

A field bus is an industrial communication system on the lowest control level of an automation system, which connects a multiplicity of field device subassemblies such as measuring sensors, final control elements and drives (actuators), but also motor starters and frequency converters having a higher-level control unit.

AS-interface (AS-i=actuator sensor interface) is a possible communication standard for communication between a master subassembly connected to the control unit and field device groups (slaves) by way of such a field bus.

In the case of a field bus designed in accordance with the AS-interface specifications the master subassembly/the master is the sole instance having the right to access the field bus in unsolicited fashion. In this situation the master cyclically sends a request to all the slaves and thus exchanges data with the slaves by means of a serial transmission protocol having a user data width of 4 bits. The slaves are not permitted, and are not able on their own initiative, to access the field bus and must wait until they are asked by the master. To this end, a unique address is assigned to each of the slaves. According to the present specification (Vers. 3.0), a maximum of 62 users can thus be connected to the master subassembly in an AS-interface.

An unshielded two-wire line preferably implemented as a ribbon cable, which can simultaneously also serve as the power supply for slaves, is used as the transmission medium for the field bus. To this end, the transmission protocol is modulated onto the voltage supply. In this situation, the Manchester coding and an alternating pulse modulation coding (APM coding) are employed. It is thus possible to realize bit times of 6 μs.

FIG. 2 shows the current functional principle of communication by way of AS-i. The individual steps of the send and receive operations are illustrated schematically in this case.

FIG. 3 shows a structure of a standard AS-i communication component within a standard AS-i module (master subassembly or slave).

### SUMMARY

At least one embodiment of the present invention is directed to an improved AS-i communication component for communication by way of an AS-i line. By preference, the communication component should be designed as space-saving and/or capable of being manufactured cost-effectively.

A communication component is disclosed for communication by way of an AS-i line, wherein a standard AS-i communication signal and an extended AS-i communication signal are sent and/or received by way of an AS-i line by way of a common communication component, wherein the frequency spectrum of the extended AS-i communication signal used for sending and/or receiving lies in the range of 1 MHz to 10 MHz. Further, a method is disclosed for sending and/or receiving communication signals by way of an AS-i line, wherein a common communication component is utilized for sending and/or receiving a standard AS-i communication signal and an extended AS-i communication signal, wherein the frequency spectrum of the extended AS-i communication signal used for sending and/or receiving lies in the range of 1 MHz to 10 MHz.

Advantageous developments of the invention are set down in the dependent claims.

The term communication is preferably understood to reside in sending and/or receiving communication signals.

### BRIEF DESCRIPTION OF THE DRAWINGS

The invention and the embodiment of the invention will be described and explained in detail in the following with reference to the exemplary embodiments illustrated in the figures. In the drawings:

FIG. 1 shows a schematic illustration of a master subassembly which is connected to a plurality of slaves by way of a bus cable,

FIG. 2 shows the current functional principle of communication by way of AS-i,

FIG. 3 shows a structure of a standard AS-i communication component within a standard AS-i module,

FIG. 4 shows a structure of an extended AS-i module,

FIG. 5 shows a frequency spectrum used by a standard AS-i communication chip and by an extended AS-i communication chip, and

FIG. 6 shows a structure of a communication component, for sending and receiving a standard AS-i communication signal and also an extended AS-i communication signal by way of an AS-i line.

### DETAILED DESCRIPTION OF THE EXAMPLE EMBODIMENTS

In order to improve the communication by way of AS-i, an additional communication signal is preferably transmitted in parallel by way of the AS-i line by using an extended AS-i communication signal which uses a higher frequency spectrum than the standard AS-i communication signal. Additional data can thus be transmitted by means of the extended AS-i communication signal.

Compared to the standard AS-i communication, the extended communication signal in this case uses a higher communication frequency spectrum, referred to in the following as extended communication frequency spectrum. The communication by way of the extended communication frequency spectrum takes place in this case preferably using the OFDM communication method (OFDM=Orthogonal Frequency Division Multiplex).

Since sending and/or receiving the standard AS-i communication signal and the extended AS-i communication signal takes place by way of the AS-i line using a common communication component, cost savings and also space savings in particular can be achieved.

In an advantageous embodiment of the invention, the communication component is an ASIC or an FPGA chip. An AS-i module must therefore preferably simply include an ASIC or FPGA chip for communication. Production costs and also the space requirement can therefore be reduced.

In a further advantageous embodiment of the invention, the frequency spectrum of the standard AS-i communication signal used for sending and/or receiving lies in the range of 50 kHz to 500 kHz and the frequency spectrum of the extended AS-i communication signal used for sending and/or receiving lies in the range of 1 MHz to 10 MHz.

In a further advantageous embodiment of the invention, the communication component uses the Orthogonal Frequency Division Multiplex method for sending and/or receiving the extended AS-i communication signal.

In a further advantageous embodiment of the invention, for receiving the standard AS-i communication signal the communication component (31) comprises a first analog to digital converter unit and for receiving the extended AS-i communication signal the communication component (31) comprises a second analog to digital converter unit, wherein preferably the first analog to digital converter unit includes a high-pass filter and the second analog to digital converter unit includes a low-pass filter.

In a further advantageous embodiment of the invention, for receiving the standard AS-i communication signal and the extended AS-i communication signal the communication component comprises a shared analog to digital converter unit. The analog to digital converter unit is in this case preferably designed in such a manner as to form a digitized value in each case from the standard AS-i communication signals and the extended AS-i communication signals.

In a further advantageous embodiment of the invention, an FFT unit is connected downstream of the analog to digital converter unit for the extended communication signal and a receive data unit is connected downstream for the standard AS-i communication signal, and the communication component comprises the FFT unit and the receive data unit. By preference, an OFDM receive data unit is connected downstream of the FFT unit. The bit sequence sent is finally retrieved by way of the receive data unit and/or OFDM receive data unit.

In a further advantageous embodiment of the invention, for sending the standard AS-i communication signal the communication component comprises a standard driver unit and for sending the extended AS-i communication signal the communication component comprises an OFDM driver unit.

Alternatively, the standard driver unit and also the OFDM driver unit can also be arranged outside the communication component.

In a further advantageous embodiment of the invention, for sending the standard AS-i communication signal and the extended AS-i communication signal the communication component comprises a shared digital to analog converter unit.

By preference, for sending a standard AS-i communication signal the communication component comprises a send data unit and for sending an extended AS-i communication signal the communication component comprises an OFDM send unit.

In a further advantageous embodiment of the invention, an AS-i module comprises a communication component for communication by way of an AS-i line. An AS-i module is in particular a slave or a master.

In a further advantageous embodiment of the invention, an OFDM driver unit and/or standard driver unit is connected downstream of the communication component for sending a standard AS-i communication signal and an extended AS-i communication signal by way of the AS-i line. The OFDM driver unit and/or standard driver unit is arranged outside the communication component in this case.

In a further advantageous embodiment of the invention, sending and/or receiving the extended AS-i communication signal takes place by means of the Orthogonal Frequency Division Multiplex method.

In a further advantageous embodiment of the invention, the standard AS-i communication signal and the extended AS-i communication signal are received by way of a shared analog to digital converter unit.

In a further advantageous embodiment of the invention, the standard AS-i communication signal and the extended AS-i communication signal are sent by way of a shared digital to analog converter unit.

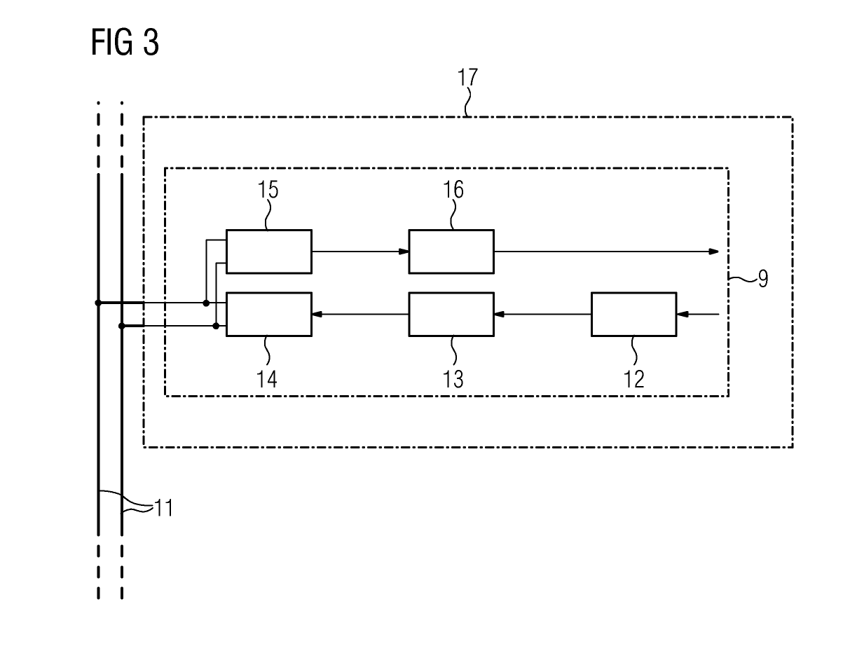

In a further advantageous embodiment, an extended AS-i module (slave or master) has a standard AS-i communication component as described under FIG. 3 and an extended communication component in order to provide extended AS-i communication in addition to the standard AS-i communication. The standard communication component and the extended communication component are preferably formed in each case by an ASIC or FPGA chip. As a result of the fact that the extended AS-i module is on the one hand able to send and receive standard AS-i communication signals by way of the standard AS-i-communication component and is also able to send and receive extended AS-i communication signals by way of the extended communication component, extended communication can take place by way of an existing AS-i line. In this manner, it is in particular possible to provide an increased data rate, which means that greater data volumes can be transmitted more quickly.

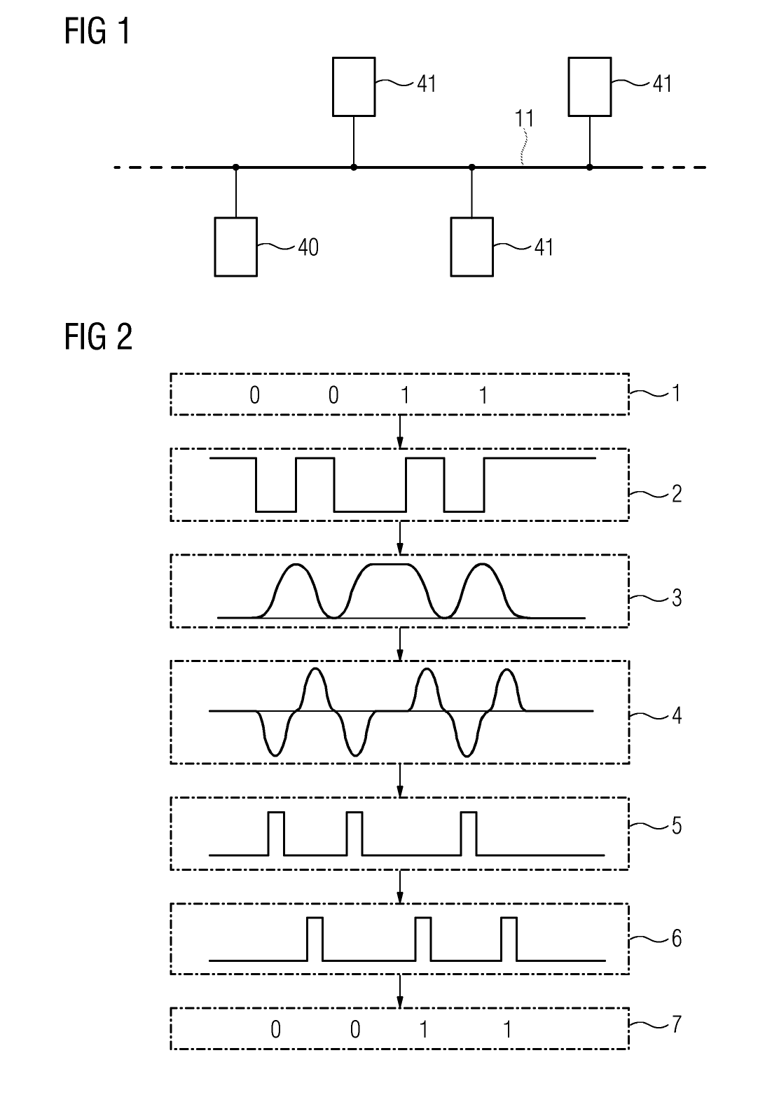

FIG. 1 shows a schematic illustration of a master subassembly 40 which is connected to a plurality of slaves 41 by way of an AS-i line (bus cable) 3. The AS-i field bus system illustrated therefore comprises the master subassembly 40, three slaves 41 and the AS-i bus cable 11. With the aid of the AS-i system, simple sensors and actuators (slaves 41) can be connected up by way of a two-wire bus 11 including the voltage supply. Each AS-interface slave 41 is freely addressable and can be connected at any desired point to the bus cable 11. As a result of the fact that each slave 41 has a specific address, for the purpose of communication with the master subassembly 40 the respective slave 41 is addressed specifically by the master subassembly 40. A slave 41 never communicates autonomously but must be addressed by the master subassembly 40 for communication with the latter and must therefore be “asked”.

FIG. 2 shows the current functional principle of communication by way of AS-i. The individual steps of the send/and also receive operation are illustrated schematically in this case.

With regard to the send operation, in a first step, for example by the master subassembly, a bit sequence 1 to be transmitted is encoded by a send data unit in Manchester coding to produce a square-wave pulse sequence 2.

In a next step, current pulses 3 are generated from the square-wave pulse sequence 2. These current pulses 3 are applied to an AS-i line connected to the master subassembly. The conversion of the square-wave pulse sequence 2 into current pulses 3 is carried out by way of a standard digital to analog converter unit. These current pulses 3 are amplified by a standard driver unit and placed onto the AS-i line.

As a result of the current pulses 3 applied, which lie in the range of approx. 0 to 60 mA, voltage levels 4 which have a voltage spike of approx. ±2 V are produced on the AS-i line. The voltage levels 4 finally form the communication signal on the AS-i line. A slave which is connected to the AS-i line can then detect these voltage levels 4 (the communication signal on the AS-i-line). The voltage levels 4 are converted by a receive device in the slave using a pulse-shaping unit into negative signals 5 or positive signals 6, such that the bit sequence 7 to be transmitted can be reconstructed in a further step by means of a receive data unit.

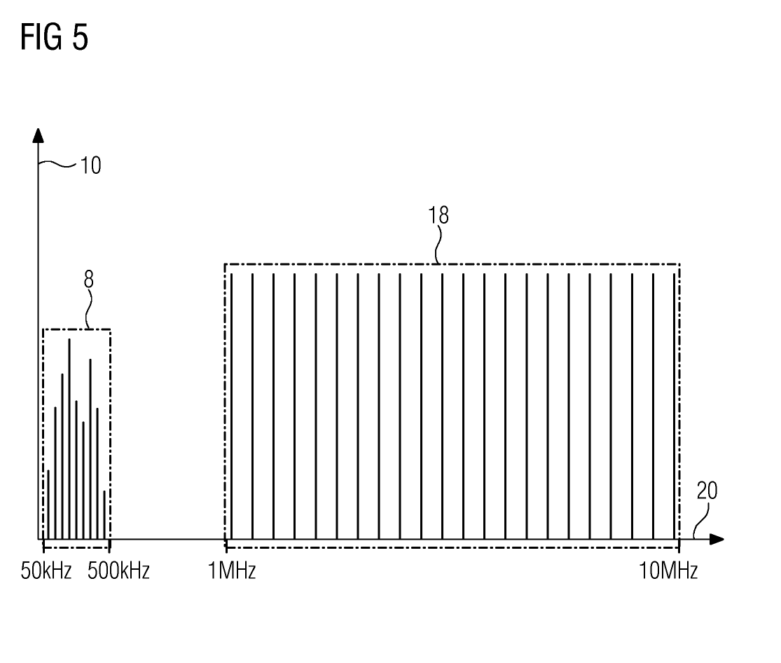

In this manner, it is possible for communication to take place between the master subassembly and a slave or vice versa. The resulting frequency spectrum of the standard AS-i communication signal is illustrated as the standard AS-i communication frequency spectrum 8 in FIG. 5. A frequency spectrum of approx. 50 to 500 kHz is occupied in this case.

FIG. 3 shows the structure of a standard AS-i communication component 9 within a standard AS-i module 17. The standard AS-i communication component 9 is included in a standard AS-i module 17 (master subassembly or slave) and makes possible standard AS-i communication by way of the AS-i line 11. For the purpose of standard AS-i communication the AS-i communication component 9 is connected in electrically conductive fashion to the two-wire AS-i line 11, such that the standard AS-i communication component 9 is able to send and also receive standard AS-i communication signals on the AS-i line 11. Standard AS-i communication, in other words sending and receiving bit sequences as described under FIG. 2, by way of an AS-line 11 is thus enabled by way of the standard AS-i communication component 9. Sending and receiving of the standard AS-i communication signals by way of the two-wire AS-i line 11 by the standard AS-i communication component 9 take place within a frequency spectrum of approx. 50 to 500 kHz.

In order to send a bit sequence, the bit sequence is firstly encoded by a send data unit 12 in Manchester coding to produce a square-wave pulse sequence. This square-wave pulse sequence is converted by a standard digital to analog converter unit 13 (D/A converter unit 13) into analog values. These analog values are amplified into current pulses by way of a standard driver unit 14 connected downstream and are fed onto the AS-i line 11. The voltage levels (standard AS-i communication signals) generated by this means on the AS-i line 11 can be decoded by a further AS-i module 17 connected to the AS-i line 11, such that the further AS-i module 17 receives the sent bit sequence.

In order to receive a bit sequence sent by way of an AS-i line 11, a voltage tap firstly takes place between the two wires of the AS-i line 11. An ascertained voltage level on the AS-i line 11 is finally converted by a pulse-shaping unit 15 into negative and positive signals, such that the sent bit sequence can be decoded by a receive data unit 16 on the basis of the negative and positive signals.

The AS-i module 17 illustrated can therefore send and also receive a bit sequence to be transmitted on the AS-i line 11 as an AS-i standard communication signal.

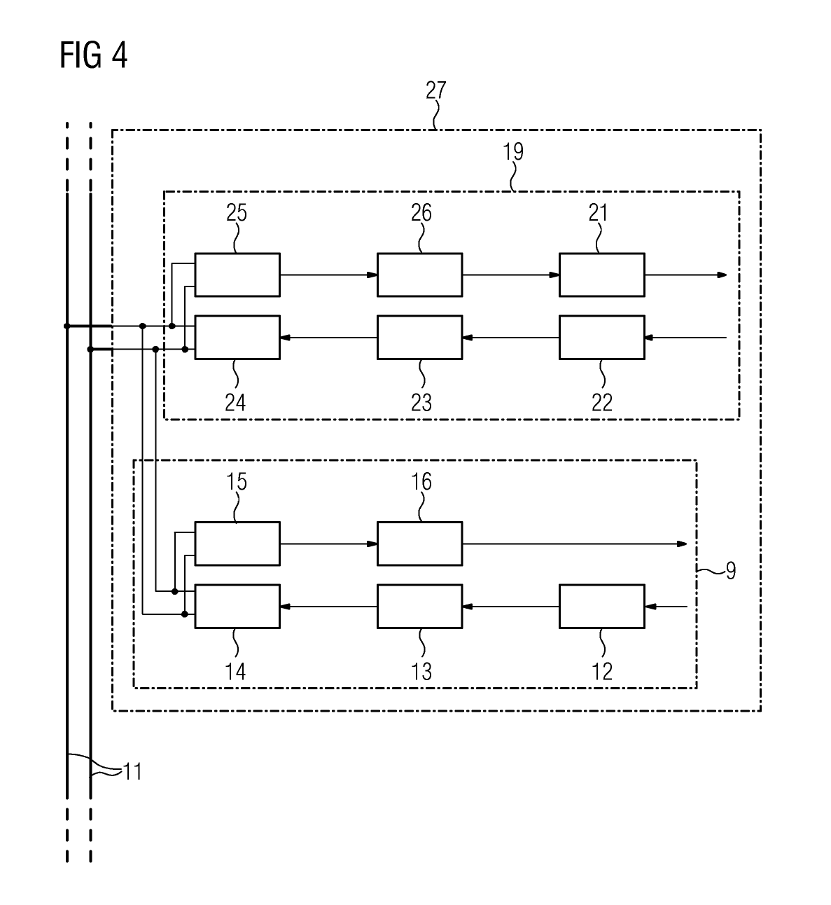

FIG. 4 shows a structure of an extended AS-i module 27. On the one hand, this extended AS-i module 27 has the standard AS-i communication component 9 described under FIG. 2. By means of this standard communication component 9 it is possible to communicate using a frequency spectrum of approx. 50 to 500 kHz.

In addition, an additional extended communication component 19 is connected in electrically conductive fashion to the AS-i line 11. Extended communication can take place on the AS-i line 11 by way of the additional extended communication component 19. A communication spectrum in the range of approx. 1 to over 10 MHz is used in this case. The communication within this frequency spectrum takes place in accordance with the OFDM communication method. OFDM (Orthogonal Frequency Division Multiplex) is an extremely bandwidth efficient multi-carrier method which utilizes the transmission channel very effectively. With regard to the OFDM decoders (FFT unit 26), a fast Fourier transform (FFT) is used for receiving, which reverses the iFFT by the OFDM send unit 22. The input data for the FFT is the digitized values of the signal from an OFDM analog to digital converter unit 25.

In order to send an extended bit sequence by way of the extended communication component 19, the extended bit sequence is firstly encoded by the OFDM send unit 22 into OFDM signals (iFFT). The encoded OFDM signals are then converted by an OFDM digital to analog converter unit 23 into OFDM communication signals, amplified by an OFDM driver unit 24 and placed onto the AS-i cable 11.

In order to receive an extended bit sequence by way of the extended communication component 19, the OFDM communication signals are tapped from the AS-i line 11 and fed to the OFDM analog to digital converter unit 25. The OFDM analog to digital converter unit 25 digitizes the analog OFDM communication signal. The extended bit sequence is retrieved from the digitized signal by way of the FFT unit 26 and an OFDM receive data unit 21 connected downstream.

By this, an increased data rate of 2 to 3 Mbps is achieved over an extended frequency spectrum. In comparison therewith, the standard AS-i communication method has a data rate of up to 160 kbps.

With regard to the extended AS-i module 27 illustrated in FIG. 4, two communication components are used (ASIC or FPGA), namely the standard AS-i communication component 9 and the extended communication component 19.

FIG. 5 shows a frequency spectrum occupied by a standard AS-i communication chip and by an extended AS-i communication chip. The first axis 10 serves to visualize the amplitude and the second axis 20 the frequency, such that the respective communication frequency spectrum can be seen. It can be seen that the standard AS-i communication frequency spectrum 8 lies in the range of approx. 50 kHz to 500 kHz whereas the extended AS-i communication frequency spectrum 18 lies in the range of approx. 1 MHz to over 10 MHz.

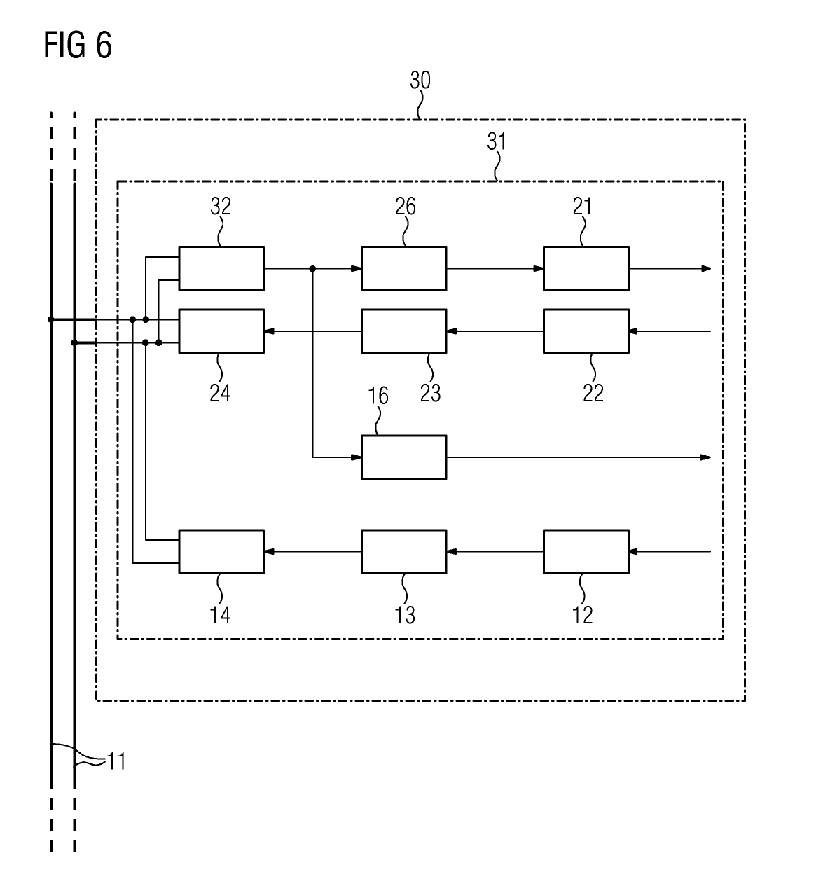

FIG. 6 shows a structure of a communication component 31 for sending and receiving a standard AS-i communication signal and also an extended AS-i communication signal by way of an AS-i line 11. In comparison with the extended AS-i module illustrated in FIG. 4, the improved AS-i module 30 illustrated here simply has one communication component 31 (ASIC or FPGA chip) for the standard AS-i communication and also for the extended AS-i communication.

The standard AS-i communication signals and also the extended AS-i communication signals are received in this case by way of a common analog to digital converter unit 32. In order to receive the extended AS-i communication signals, an FFT unit 26 and also an OFDM receive data unit 21 are connected downstream of the analog to digital converter unit 32, such that a bit sequence sent by way of the extended AS-i communication signal can be retrieved. In order to receive the standard AS-i communication signals, a receive data unit 16 is connected downstream of the analog to digital converter unit 32, such that a bit sequence sent by way of the standard AS-i communication signal can be retrieved.

In order to send the standard AS-i communication signals and also the extended AS-i communication signals the communication component 31 comprises an OFDM digital to analog converter unit 23 for the extended AS-i communication signal and a standard digital to analog converter unit 13 for the standard AS-i communication signal. It is likewise conceivable that a shared digital to analog converter unit is used for the standard AS-i communication signal and also for the extended AS-i communication signal. The digital to analog converter unit 13, 23 forms an analog value from the digital values.

A send data unit 12 is connected upstream of the standard digital to analog converter unit 13 and encodes a bit sequence to be transmitted in accordance with standard AS-i communication by way of Manchester coding into a square-wave pulse sequence. An OFDM send unit 22 on the other hand firstly encodes the extended bit sequence to be transmitted in accordance with the Orthogonal Frequency Division Multiplex method into OFDM signals (iFFT) and forwards the latter to the OFDM digital to analog converter unit 23.

In order to amplify the signal, a driver unit (standard driver unit 14 and OFDM driver unit 24) is connected downstream in each case of the standard digital to analog converter unit 13 and the OFDM digital to analog converter unit 23. It is likewise conceivable that the standard driver unit 14 and the OFDM driver unit 23 are arranged outside the communication component 31 and are connected thereto and to the AS-i line 11 in electrically conductive fashion.

1. A communication component for communication by way of an AS-i line, wherein a standard AS-i communication signal and an extended AS-i communication signal are at least one of sendable and receiveable by way of the AS-i line by way of the common communication component, wherein a frequency spectrum of the extended AS-i communication signal, used for at least one of sending and receiving, lies in the range of 1 MHz to 10 MHz.

2. The communication component of claim 1, wherein the communication component is an ASIC or an FPGA chip.

3. The communication component of claim 1, wherein the frequency spectrum of the standard AS-i communication signal used for at least one of sending and receiving lies in the range of 50 kHz to 500 kHz and the frequency spectrum of the extended AS-i communication signal used for at least one of sending and receiving lies in the range of 1 MHz to 10 MHz.

4. The communication component of claim 1, wherein the communication component uses the Orthogonal Frequency Division Multiplex method for at least one of sending and receiving the extended AS-i communication signal.

5. The communication component of claim 1, further comprising:
a first analog to digital converter unit for receiving the standard AS-i communication signal; and
a second analog to digital converter unit for receiving the extended AS-i communication signal.

6. The communication component of claim 1, further comprising:
a shared analog to digital converter unit for receiving the standard AS-i communication signal and the extended AS-i communication signal.

7. The communication component of claim 5, further comprising:
an FFT unit, is connected downstream of the second analog to digital converter units for the extended communication signal; and
a receive data unit, connected downstream of the first analog to digital converter unit for the standard AS-i communication signal.

8. The communication component of claim 1, further comprising:
a standard driver unit for sending the standard AS-i communication signal; and
an OFDM driver unit for sending the extended AS-i communication signal.

9. The communication component of claim 1, further comprising:
a shared digital to analog converter unit for sending the standard AS-i communication signal and the extended AS-i communication signal.

10. An AS-i module, comprising
a communication component of claim 1 for communication by way of an AS-i line.

11. The AS-i module of claim 10, wherein at least one of an OFDM driver unit standard driver unit is connected downstream of the communication component for sending the standard AS-i communication signal and an extended AS-i communication signal by way of the AS-i line.

12. A method for at least one of sending and receiving communication signals by way of an AS-i line, comprising:
using a common communication component for at least one of sending and receiving a standard AS-i communication signal and an extended AS-i communication signal, wherein a frequency spectrum of the extended AS-i communication signal used for at least one of sending and receiving lies in the range of 1 MHz to 10 MHz.

13. The method of claim 12, wherein the at least one of sending and receiving of the extended AS-i communication signal takes place by way of an Orthogonal Frequency Division Multiplex method.

14. The method of claim 12, wherein the standard AS-i communication signal and the extended AS-i communication signal are received by way of a shared analog to digital converter unit.

15. The method of claim 12, wherein the standard AS-i communication signal and the extended AS-i communication signal are sent by way of a shared digital to analog converter unit.

16. The communication component of claim 2, wherein the frequency spectrum of the standard AS-i communication signal used for at least one of sending and receiving lies in the range of 50 kHz to 500 kHz and the frequency spectrum of the extended AS-i communication signal used for at least one of sending and receiving lies in the range of 1 MHz to 10 MHz.

17. The communication component of claim 2, wherein the communication component uses the Orthogonal Frequency Division Multiplex method for at least one of sending and receiving the extended AS-i communication signal.

18. The communication component of claim 2, further comprising:
a first analog to digital converter unit for receiving the standard AS-i communication signal; and
a second analog to digital converter unit for receiving the extended AS-i communication signal.

19. The communication component of claim 5, wherein the first analog to digital converter unit includes a high-pass filter and the second analog to digital converter unit includes a low-pass filter.

20. The communication component of claim 18, wherein the first analog to digital converter unit includes a high-pass filter and the second analog to digital converter unit includes a low-pass filter.

21. The communication component of claim 2, further comprising:
a shared analog to digital converter unit for receiving the standard AS-i communication signal and the extended AS-i communication signal.

22. The communication component of claim 6, further comprising:
an FFT unit, connected downstream of the shared analog to digital converter unit, for the extended communication signal; and
a receive data unit, connected downstream of the shared analog to digital converter unit, for the standard AS-i communication signal.

23. The method of claim 13, wherein the standard AS-i communication signal and the extended AS-i communication signal are received by way of a shared analog to digital converter unit.
